(19) United States
(12) Patent Application Publication
(10) Pub. No.: US 2015/0212559 A1
(43) Pub. Date: Jul. 30, 2015

(54) Electronic Apparatus Including Programmable Logic Circuit Device and Rewriting Method

(71) Applicant: KONICA MINOLTA, INC., Tokyo (JP)

(72) Inventor: Toshihiro Ono, Tokyo (JP)

(21) Appl. No.: 14/606,937

(22) Filed: Jan. 27, 2015

(30) Foreign Application Priority Data
Jan. 30, 2014 (JP) 2014-016114

(51) Int. Cl. G06F 1/24; G06F 9/445; G06F 1/26; G06F 13/24

(52) U.S. Cl. CPC G06F 1/24; G06F 13/24; G06F 9/44505; G06F 1/26

(57) ABSTRACT

An electronic apparatus of the present invention includes a microprocessor, a programmable logic circuit device, and a signal interruption unit. The programmable logic circuit device controls at least one of power supply and reset of the microprocessor. The signal interruption unit interrupts a control signal for controlling at least one of power supply and reset of the microprocessor by the programmable logic circuit device, while the microprocessor rewrites circuit configuration data of the programmable logic circuit device.

### CROSS-REFERENCE TO RELATED APPLICATION

This application is based on Japanese Patent Application No. 2014-016114 filed on Jan. 30, 2014, the contents of which are incorporated herein by reference.

### BACKGROUND

1. Technical Field

The present invention relates to an electronic apparatus comprising a programmable logic circuit device and a rewriting method.

2. Description of Related Art

A programmable logic circuit device (hereinafter, also referred to as “PLD”) is a logic circuit device inside which a logic circuit can be changed repeatedly unlike a logic circuit device inside which, once a logic circuit is determined, the logic circuit can not be changed such as an ASIC (Application Specific Integrated Circuit).

Regarding a PLD (Programmable Logic Device) in recent years, a user can edit a desired configuration of a logic circuit on a terminal such as a personal computer, and the PLD can read information on the configuration of the logic circuit as configuration data to configure the logic circuit in the device.

For example, Japanese Unexamined Publication No. 2008-123147 discloses an on-board rewriting system comprising a PLD and a microprocessor (hereinafter, also referred to as “MPU”) in which configuration data is rewritten by a remote control center.

In a flash memory-incorporated on-board rewriting system comprising a PLD, the state of an output terminal of PLD is, however, usually undefined while an MPU (Micro-Processing Unit) rewrites a PLD. Accordingly, in the case of a configuration in which a PLD controls power on or reset of an MPU, there is a risk that configuration data can not be rewritten or can not normally be rewritten from the MPU.

The present invention has been made in view of the above-mentioned problems. Therefore, an object of the present invention is to provide an electronic apparatus comprising a PLD and a rewriting method in which, in the case of a configuration in which the PLD controls power on or reset of an MPU, configuration data of the PLD can be normally rewritten from the MPU.

### SUMMARY

In order to achieve at least one of the above-mentioned objects, an electronic apparatus according to one aspect of the present invention comprises: a microprocessor; a programmable logic circuit device which controls at least one of power supply and reset of the microprocessor; and a signal interruption unit which interrupts a control signal for controlling at least one of power supply and reset of the microprocessor by the programmable logic circuit device, while the microprocessor rewrites circuit configuration data of the programmable logic circuit device.

Preferably, the programmable logic circuit device incorporates a rewritable nonvolatile memory and the rewritable nonvolatile memory stores the circuit configuration data.

Preferably, the signal interruption unit cancels interruption of the control signal after completion of rewriting circuit configuration data of the programmable logic circuit device, and the programmable logic circuit device initializes the whole electronic apparatus after the signal interruption unit cancels interruption of the control signal.

Preferably, the programmable logic circuit device controls at least one of power supply and reset of a device comprising the microprocessor.

Preferably, the microprocessor comprises two operation modes, a normal operation mode and a PLD rewriting operation mode, and while the microprocessor rewrites circuit configuration data of the programmable logic circuit device when the operation mode is the PLD rewriting operation mode, the microprocessor executes read/write on a device other than the programmable logic circuit device when the operation mode is the normal operation mode.

Preferably, the electronic apparatus further comprises: a storage unit as the other device; and a selection unit which selects any of the programmable logic circuit device and the storage unit depending on the operation mode.

Preferably, the signal interruption unit comprises a tri-state buffer to which the control signal is input and which outputs to the microprocessor, and while, when the operation mode is the PLD rewriting operation mode, the tri-state buffer is in a high impedance state and therefore the control signal is interrupted from the microprocessor, when the operation mode is the normal operation mode, the tri-state buffer is in a conductive state and therefore the control signal is input to the microprocessor.

Preferably, an electric power is supplied to the tri-state buffer from the same power source as a power source which supplies an electric power to the programmable logic circuit device.

Preferably, a pull-up resistor or a pull-down resistor is connected to an output terminal of the tri-state buffer, and when the tri-state buffer is in a high impedance state, the output terminal is pulled up or pulled down such that an operation of the microprocessor continues.

Preferably, a pull-up resistor or a pull-down resistor is connected to an input terminal of the tri-state buffer, and when the control signal is unstable, the input terminal is pulled up or pulled down such that an operation of the microprocessor is not started.

Preferably, a pull-up resistor or a pull-down resistor is connected to an enable terminal of the tri-state buffer, and the enable terminal is pulled up or pulled down such that the tri-state buffer is in an enable state.

Preferably, the signal interruption unit comprises an analog switch to which the control signal is input and which outputs to the microprocessor, and while, when the operation mode is a PLD rewriting operation mode, the analog switch is in a high impedance state and therefore the control signal is interrupted from the microprocessor, when the operation mode is the normal operation mode, the analog switch is in a conductive state and therefore the control signal is input to the microprocessor.

Preferably, an electric power is supplied to the analog switch from the same power source as a power source which supplies an electric power to the programmable logic circuit device.

Preferably, a pull-up resistor or a pull-down resistor is connected to an output terminal of the analog switch, and when the analog switch is in a high impedance state, the output terminal is pulled up or pulled down such that an operation of the microprocessor continues.

Preferably, a pull-up resistor or a pull-down resistor is connected to an input terminal of the analog switch, and when the control signal is unstable, the input terminal is pulled up or pulled down such that an operation of the microprocessor is not started.

Preferably, a pull-up resistor or a pull-down resistor is connected to an enable terminal of the analog switch, and the enable terminal is pulled up or pulled down such that the analog switch is in an enable state.

Preferably, a pull-up resistor or a pull-down resistor of an input terminal of the analog switch and a pull-up resistor or a pull-down resistor of an output terminal of the analog switch are determined such that the control signal is in a logic level by which an operation of the microprocessor is not started by the resistance ratio determined by each of the resistance values.

Preferably, the control signal is either high level or low level output of LVTTL or a high impedance output by an open collector.

The objects, features, and characteristics of this invention other than those set forth above will become apparent from the description given herein below with reference to preferred embodiments illustrated in the accompanying drawings.

### BRIEF DESCRIPTION OF THE DRAWINGS

FIG. 1 is a block diagram illustrating a rough configuration of an electronic apparatus comprising a PLD in a first embodiment of the present invention.

FIG. 2 is a flowchart for explaining an overview of an operation of the electronic apparatus comprising a PLD in the first embodiment of the present invention.

FIG. 3 is a flowchart explaining a procedure for rewriting configuration data in the first embodiment of the present invention.

FIG. 4 is a block diagram illustrating a rough configuration of an electronic apparatus comprising a PLD in a second embodiment of the present invention.

FIG. 5 is a block diagram illustrating a rough configuration of an electronic apparatus comprising a PLD in a third embodiment of the present invention.

### DETAILED DESCRIPTION

The embodiments of this invention will be described below with reference to the accompanying drawings.

### First Embodiment

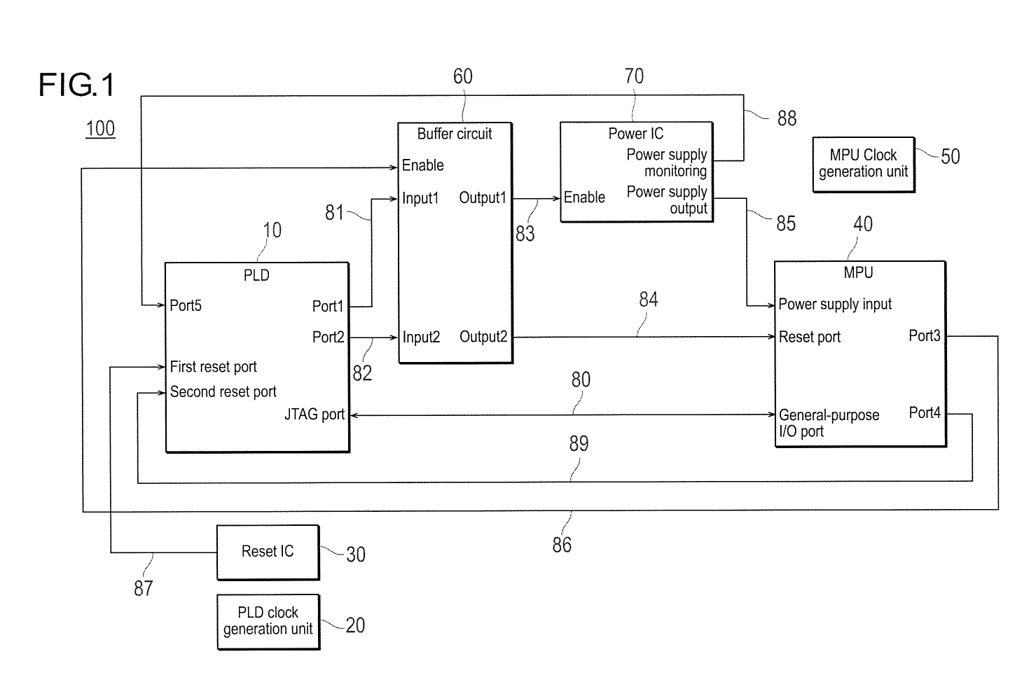

FIG. 1 is a block diagram illustrating a rough configuration of an electronic apparatus comprising a PLD in a first embodiment of the present invention. As illustrated in FIG. 1, an electronic apparatus 100 of this embodiment comprises a PLD 10, a PLD clock generation unit 20, a reset IC 30, an MPU 40, an MPU clock generation unit 50, a buffer circuit 60, and a power IC (Integrated Circuit) 70. These components are electrically connected with each other by wirings 80 to 89.

The PLD 10 is a programmable logic circuit device which controls on/off of power and reset of the MPU 40. The PLD 10 incorporates a flash memory (rewritable nonvolatile memory) storing configuration data (circuit configuration data), and comprises terminals of a port 1, a port 2, a port 5, a JTAG port, and a first and a second reset port.

The terminals of the port 1 and the port 2 are connected to an input 1 terminal and an input 2 terminal of the buffer circuit 60 via the wirings 81 and 82, respectively, and a port 5 terminal is connected to a power supply monitoring terminal of a power IC 70 via the wiring 88. A JTAG (Joint Test Action Group) port terminal is connected to a general-purpose I/O port terminal of the MPU 40 via the wiring 80. A first reset port terminal is connected to the reset IC 30 via the wiring 87, and a second reset port terminal is connected to a port 4 terminal of the MPU 40 via the wiring 89.

The JTAG port of this embodiment is in accordance with the IEEE 1149.1 standard of a test access port. Although the JTAG is a standard which had been used for testing an integrated circuit or a substrate at the beginning, in recent years, the JTAG is used not only for the purpose of testing but also for a means of accessing CPLD or FPGA such as rewriting of configuration data.

To the electronic apparatus 100 of this embodiment, an electric power is supplied by a power supply (for example, power supply voltage: 3.3V) outside the electronic apparatus 100 which is not illustrated. The power supply supplies an electric power to the PLD 10 and the PLD clock generation unit 20 which supplies a PLD clock signal to the PLD 10.

The PLD 10 of this embodiment generates a power supply control signal for controlling enabling of the power IC 70 and outputs the power supply control signal from the port 1 terminal. The power supply control signal is input to the input 1 terminal of the buffer circuit 60.

The PLD 10 confirms that a power supply voltage which is output from a power supply output terminal of the power IC 70 to the wiring 85 is an appropriate voltage based on a power supply monitoring signal of the power IC 70 which is input to the port 5 terminal. The PLD 10 generates a reset control signal for controlling resetting of the MPU 40 and outputs the reset control signal from a port 2 terminal. The reset control signal is input to the input 2 terminal of the buffer circuit 60.

The PLD clock generation unit 20 comprises an oscillator or a vibrator, and generates a PLD clock signal. A clock output terminal of the PLD clock generation unit 20 is connected to a clock input terminal of the PLD 10. In FIG. 1, a clock output terminal of the PLD clock generation unit 20, a clock input terminal of the PLD 10, and a wiring between the PLD clock generation unit 20 and the PLD 10 are not illustrated.

The reset IC 30 resets the PLD 10 for a predetermined time after an electric power is started to be supplied from the above-mentioned power supply to the PLD 10 until the waveform of the above-mentioned PLD clock signal is stabilized.

The MPU 40 acquires rewriting data of configuration data of the PLD 10, and rewrites existing configuration data which is stored in a flash memory of the PLD 10 into the above-mentioned rewriting data. The MPU 40 is a general-purpose microprocessor, and comprises terminals of a power supply input, a reset port, a general-purpose I/O port, a port 3, and a port 4. A power supply input terminal is connected to a power supply output terminal of the power IC 70 via the wiring 85, and a reset port terminal is connected to an output 2 terminal of the buffer circuit 60 via the wiring 84. The general-purpose I/O port terminal is connected to a JTAG port terminal of the PLD 10 via the wiring 80. A port 3 terminal is connected to an enable terminal of the buffer circuit 60 via the wiring 86, and a port 4 terminal is connected to the second reset port terminal of the PLD 10 via the wiring 89.

In this embodiment, the MPU 40 outputs the acquired rewriting data of configuration data from the general-purpose I/O port terminal and transmits the acquired rewriting data of configuration data to the JTAG port terminal of the PLD 10 using a JTAG protocol

To the MPU 40, the MPU clock generation unit 50 is connected. The MPU clock generation unit 50 comprises an oscillator or a vibrator, and generates a clock signal for the MPU. The above-mentioned oscillator operates by the same power supply as that of the MPU 40. The above-mentioned vibrator starts oscillation when a voltage is applied to the vibrator from a terminal of the MPU 40. The PLD 10 cancels reset after waiting for timing for applying each power supply for the MPU 40 and a clock stable output of the MPU clock generation unit 50. In FIG. 1, a clock output terminal of the MPU clock generation unit 50, a clock input terminal of the MPU 40, and a wiring between the MPU clock generation unit 50 and the PLD 10 are not illustrated.

To the MPU 40, a plurality of power supplies (IO power supplies) for device interfaces are connected. The power supply voltage of the above-mentioned power supply is, for example, 3.3V, 1.8V, 1.5V, or 1.2V. Therefore, the PLD 10 desirably outputs an on/off control signal for each of the above-mentioned power supplies. However, when the MPU 40 does not contain a power supply sequence, all power supplies may be simultaneously controlled in an on/off manner.

Before the MPU 40 starts up (in a reset state), the port 3 terminal of the MPU 40 is in a high impedance (hereinafter referred to as “HiZ”) state and is electrically in a floating state. For this reason, for example, in cases in which enable of the buffer circuit 60 is in a negative logic state, the port 3 terminal of the MPU 40 is logically fixed by a pull-down resistor (not illustrated).

The buffer circuit 60 functions as a signal interruption unit, and interrupts an MPU control signal which controls the MPU 40 by the PLD 10. In this embodiment, the MPU control signal includes a power supply control signal which controls power supply and a reset control signal which controls reset of the MPU 40. The MPU control signal is preferably a “high level” or “low level” output of LVTTL or the like or a HiZ output by an open collector.

The buffer circuit 60 comprises two one-input one-output switching elements which can perform an enable/disable control, and comprises terminals of enable, input 1, input 2, output 1, and output 2. Examples of the above-mentioned switching elements include a tri-state buffer or an analog switch. When the buffer circuit 60 is in an enable state, to the output 1 terminal, a power supply control signal which has been input to the input 1 terminal is output, and to the output 2 terminal, a reset control signal which has been input to the input 2 terminal is output.

On the other hand, when the buffer circuit 60 is not in an enable state, in other words, when the buffer circuit is in a disable state, the output 1 terminal and output 2 terminal are in a HiZ state and is in an electrically floating state. In this embodiment, enable of the buffer circuit 60 is a negative logic, and when a “low level” buffer enabling signal is input to an enable terminal of the buffer circuit 60, the buffer circuit 60 is in an enable state. On the other hand, when a “high level” buffer enabling signal is input to the enable terminal, the buffer circuit is in a disable state.

The output 1 terminal is connected to an enable terminal of the power IC 70 and outputs a power supply control signal to the wiring 83. The output 2 terminal is connected to a reset port terminal of the MPU 40 and outputs a reset control signal to the wiring 84.

In this embodiment, the power IC 70 maintains an enable state even when the above-mentioned output 1 terminal and output 2 terminal are in a HiZ state, and in order for the MPU 40 not to be reset, the output 1 terminal and output 2 terminal are logically fixed to “low level” or “high level”. For example, as in this embodiment, in cases in which enable of the power IC 70 is a positive logic and reset of the MPU 40 is a negative logic, the above-mentioned output 1 terminal and output 2 terminal are logically fixed by a pull-up resistor (not illustrated). The same voltage as that of the power supply voltage of the power IC 70 is preferably applied to the above-mentioned pull-up resistor.

To the input 1 terminal and input 2 terminal of the buffer circuit 60, a pull-up resistor or a pull-down resistor may be connected. For example, in cases in which an MPU control signal is unstable such as in a case in which the PLD 10 is reset for the first time, operation of the MPU 40 is preferably not allowed to be started by not supplying power or by pulling up or pulling down the input 1 terminal and input 2 terminal to reset.

In cases in which the buffer circuit 60 comprises an analog switch as a switching element, when the buffer circuit 60 is in an enable state, the input side and the output side are in a conductive state, and therefore, a pull-up resistor /a pull-down resistor on the input side and output side are connected to each other on a signal wire. Therefore, a pull-up resistor /a pull-down resistor of the input terminal and a pull-up resistor /a pull-down resistor of the output terminal of the analog switch are determined by resistance ratios determined by individual resistance values such that an MPU control signal is a logic level by which operation of the MPU 40 does not start.

The power IC 70 is an IC for supplying an electric power to the MPU 40, and comprises terminals of enable, power supply monitoring, and power supply output. When a power supply control signal which is input to the above-mentioned enable terminal is active and the power IC 70 is in an enable state, an electric power which is needed for the MPU 40 is supplied via the power supply output terminal. On the other hand, when the power IC is not an enable state, an electric power is not supplied to the MPU 40.

In this embodiment, the power supply monitoring terminal outputs whether a terminal voltage of the power supply output terminal is a predetermined voltage or not, and supplies the terminal voltage to the port 5 terminal of the PLD 10. As mentioned above, in order for the power IC 70 to maintain an enable state even when the output 1 terminal and the output 2 terminal are in a HiZ state, and in order for the MPU 40 not to be reset, the output 1 terminal and the output 2 terminal are pulled up.

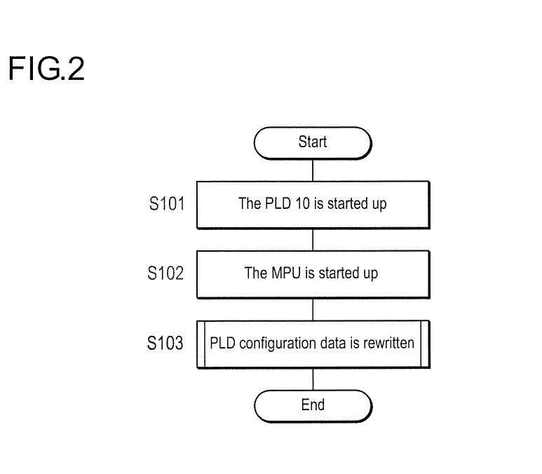

Next, with reference to FIG. 2, an overview of an operation of the electronic apparatus 100 of this embodiment as configured above will be described. FIG. 2 is a flowchart for explaining an overview of an operation of the electronic apparatus comprising a PLD in the first embodiment of the present invention.

As illustrated in FIG. 2, firstly, the PLD 10 is started up (step S101). Specifically, an electric power is supplied to the PLD 10 from a power supply outside the electronic apparatus 100. In this embodiment, the power supply voltage which is supplied to the PLD 10 is, for example, 3.3V. In this embodiment, an electric power is supplied from the above-mentioned power supply also to the PLD clock generation unit 20 for supplying a clock signal to the PLD 10.

When an electric power and a PLD clock signal are started to be supplied to the PLD 10, the PLD 10 starts operation. However, since it is assumed that, immediately after an electric power is started to be supplied to the PLD clock generation unit 20, the waveform of the generated PLD clock signal is not stabilized, the PLD 10 is reset by the reset IC 30 until the PLD clock signal is stabilized. Then, after a predetermined time for stabilizing the PLD clock signal, the reset is cancelled to complete start-up of the PLD 10.

Next, the MPU is started up (step S102). Specifically, after completion of start-up of the PLD 10, the PLD 10 outputs a power supply control signal from the port 1 terminal to the wiring 81. To the power IC 70, the above-mentioned power supply control signal is input from the enable terminal via the buffer circuit 60. The power IC 70 starts supplying an electric power to the MPU 40 when the above-mentioned power supply control signal has been input to the power IC.

When the above-mentioned power supply control signal has been input to the power IC 70 and the power supply output terminal has become a predetermined voltage, the power IC outputs a power supply monitoring signal from the power supply monitoring terminal. The PLD 10 inputs the above-mentioned power supply monitoring signal to the port 5 terminal and confirms that a voltage which has been output from the power IC 70 to the wiring 85 is a predetermined voltage.

Further, the PLD 10 outputs a reset control signal from the port 2 terminal to the wiring 82. When the reset control signal is input to the MPU 40 from the reset port terminal, the MPU becomes in a reset state.

After the above-mentioned power supply monitoring signal is input to the PLD 10, the PLD starts timing, and after a predetermined time, the PLD makes the reset control signal inactive to cancel the reset of the MPU 40. Then, the MPU 40 reads a software program stored in a ROM (Read Only Memory) which is not illustrated and starts a predetermined operation. The following procedure for rewriting PLD configuration data is realized when the MPU 40 executes a rewriting program stored in the above-mentioned ROM.

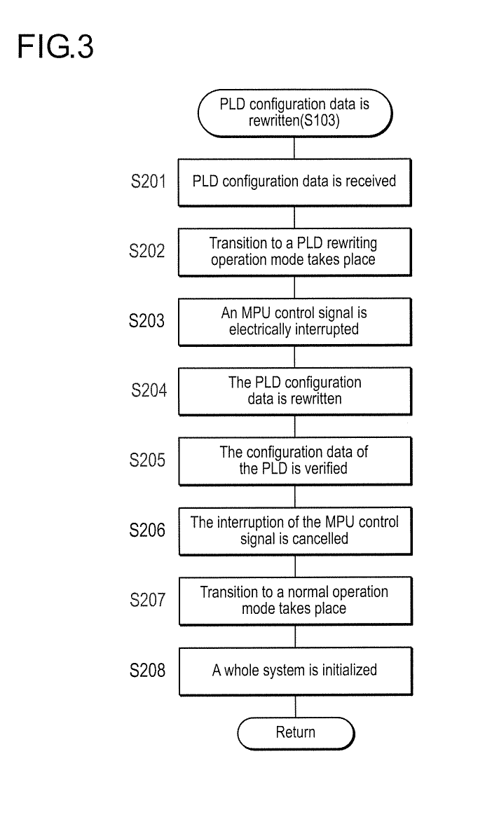

Next, the PLD configuration data is rewritten (step S103). The MPU 40 rewrites configuration data stored in a flash memory of the PLD 10. The procedure for rewriting configuration data in this embodiment will be concretely described with reference to FIG. 3. FIG. 3 is a flowchart explaining a procedure for rewriting configuration data in this embodiment.

As illustrated in FIG. 3, firstly, PLD configuration data is received (step S201). The MPU 40 receives configuration data for rewriting of the PLD 10 from an external interface which is not illustrated such as LAN or USB.

Next, transition to a PLD rewriting operation mode takes place (step S202). The MPU 40 stops execution of an application software, and switches an operation mode from a normal operation mode to the PLD rewriting operation mode.

Next, an MPU control signal is electrically interrupted (step S203). The MPU 40 makes a buffer enabling signal which is output from the port 3 terminal to the wiring 86 inactive, and makes the output 1 terminal and output 2 terminal of the buffer circuit 60 in a HiZ state. By this, the power supply control signal which is output from the PLD 10 to the power IC 70 via the buffer circuit 60 and the reset control signal which is output to the MPU 40 via the buffer circuit 60 are separated from the control of the PLD 10.

As mentioned above, when the buffer enabling signal becomes inactive, the output 1 terminal and output 2 terminal of the buffer circuit 60 become in a HiZ state. In this embodiment, the output 1 terminal and output 2 terminal of the buffer circuit 60 are logically fixed to “high level”, for example, by an external pull-up resistor. Since enable of the power IC 70 is a positive logic and the power supply control signal is logically fixed to “high level”, power supply to the MPU 40 is continued. In a similar manner to the above, in this embodiment, since reset of the MPU 40 is a negative logic and an MPU reset signal is logically fixed to “high level”, the MPU 40 is not reset, and the MPU 40 continues an operation.

Next, configuration data of the PLD is rewritten (step S204). The MPU 40 transmits the above-mentioned configuration data for rewriting from the general-purpose I/O port terminal to the JTAG port terminal of the PLD 10 using a JTAG protocol. The PLD 10 rewrites configuration data stored in an incorporated flash memory to the above-mentioned configuration data for rewriting.

Next, the configuration data of the PLD is verified (step S205). The PLD 10 transmits the rewritten configuration data from the JTAG port terminal to the general-purpose I/O port terminal of the MPU 40 using a JTAG protocol. The MPU 40 verifies the configuration data of the PLD 10 received by the general-purpose I/O port terminal by comparing the configuration data with the above-mentioned configuration data for rewriting. When the configuration data of the PLD 10 has an error as the result of the verification, the process of the step S204 may be executed again, and alternatively, an error code may be output or an interrupt to the MPU 40 may be generated.

The PLD 10 can start an operation immediately after configuration data has been rewritten. Alternatively, the PLD 10 can be configured to start an operation immediately after a PLD reset signal which is output from the port 4 terminal of the MPU 40 to the wiring 89 become inactive after configuration data has been rewritten.

In addition, the PLD 10 executes a start-up processing of the MPU 40 in the above-mentioned step S102. Here, since the buffer circuit 60 is in an inactive state as mentioned above, although the MPU control signal from the PLD 10 is electrically separated, the output 1 terminal and output 2 terminal are logically fixed to “high level” by a pull-up resistor. Therefore, the power IC 70 maintains the enable state, and the power supply output terminal of the power IC 70 outputs a predetermined power supply voltage. As a result, the PLD 10 determines that the start-up processing of the MPU 40 is performed as usual by the power supply monitoring signal which is output from the power supply monitoring terminal of the power IC 70.

Ina start-up sequence of the MPU 40 which is executed in the PLD 10, a reset control of the MPU 40 is also performed. Therefore, if the output from the port 3 terminal of the MPU 40 is set to “low level” and the buffer circuit 60 is enabled before the above-mentioned start-up sequence completes, the MPU 40 itself is reset. In this case, the PLD 10 is not reset and only the MPU 40 is reset to be initialized, and therefore, initializations of the PLD 10 and the MPU 40 are not appropriately synchronized, which is not preferred.

Next, the interruption of the MPU control signal is cancelled (step S206). The MPU 40 waits until the sequence by the PLD 10 is completed, and then a buffer enabling signal which is output from the port 3 terminal is made active to restore the buffer circuit 60 to an enable state.

Next, transition to a normal operation mode takes place (step S207). The MPU 40 switches the operation mode of the PLD 10 from a PLD rewriting operation mode to a normal operation mode.

Next, a whole system is initialized (step S208). The MPU 40 initializes the whole electronic apparatus 100 by making the PLD reset signal of the PLD 10 which is output from the port 4 terminal active.

As mentioned above, in a method of rewriting configuration data of the PLD of this embodiment as illustrated in FIG. 3, firstly, configuration data for rewriting of the PLD 10 is acquired. Then, after the buffer circuit 60 interrupts an MPU control signal which controls power supply and reset of the MPU 40, the MPU 40 rewrites configuration data of PLD 10.

As mentioned above, the electronic apparatus 100 and the rewriting method of this embodiment attains the following effect.

Since the MPU 40 interrupts an MPU control signal which controls power supply and reset of the MPU 40 while configuration data of the PLD 10 is rewritten, the configuration data of the PLD 10 can be normally rewritten from the MPU 40.

### Second Embodiment

An electronic apparatus of a second embodiment has the configuration of the electronic apparatus of the first embodiment, and further comprises a memory on which the MPU reads/writes in a normal operation mode. In the following, an explanation for the same configuration as that of the first embodiment is omitted.

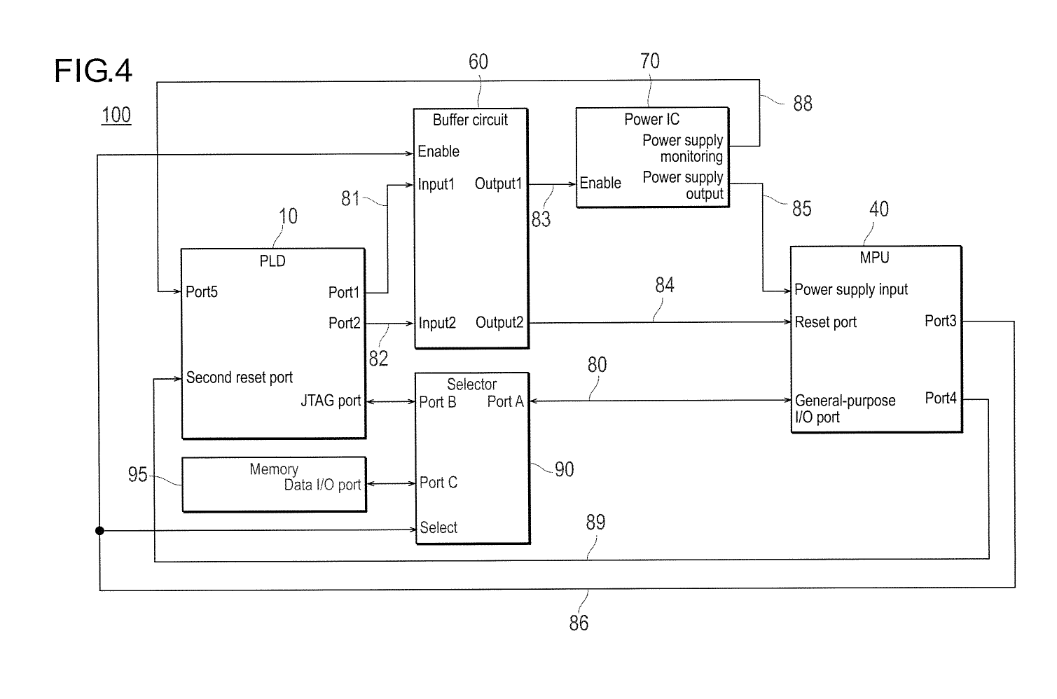

FIG. 4 is a block diagram illustrating a rough configuration of an electronic apparatus comprising a PLD according to the second embodiment. As illustrated in FIG. 4, an electronic apparatus 100 of this embodiment comprises a selector 90 and a memory 95. In FIG. 4, a PLD clock generation unit, a reset IC and an MPU clock generation unit are not illustrated.

The selector 90 inputs data from a general-purpose I/O port of an MPU 40 and outputs the data to a JTAG port of a PLD 10 or a data I/O port of the memory 95. The selector 90 comprises terminals of a port A, a port B, a port C and a select. The port A terminal is connected to the general-purpose I/O port terminal of the MPU 40, the port B terminal is connected to the JTAG port terminal of the PLD 10, the port C terminal is connected to the data I/O port terminal of the memory 95, and the select terminal is connected to the port 3 terminal of the MPU 40.

The memory 95 comprises a storage device such as a ROM (Read Only Memory) or a RAM which is not illustrated. In a normal operation mode, the general-purpose I/O port terminal of the MPU 40 and the data I/O port terminal of the memory 95 are connected to each other by the selector 90. The MPU 40 writes a software program or data to the memory 95, or reads a software program or data from the memory 95.

On the other hand, in a PLD rewriting operation mode, the MPU 40 disables a buffer circuit 60, and the general-purpose I/O port terminal of the MPU 40 and the JTAG port terminal of the PLD 10 are connected to each other by the selector 90. The MPU 40 executes rewriting of configuration data of the PLD 10 and initialization of the whole electronic apparatus 100 in a similar manner to the rewriting procedure of PLD configuration data in the first embodiment.

The general-purpose IO port of the MPU 40 emulates an interface with the memory 95 to execute read/write in the normal operation mode, and emulates a JTAG protocol to rewrite configuration data of the PLD 10 in the PLD rewriting operation mode.

As mentioned above, in this embodiment, in the normal operation mode, the general-purpose I/O port terminal of the MPU 40 and the data I/O port terminal of the memory 95 are connected to each other such that the MPU 40 can execute read/write to the memory 95. On the other hand, in the PLD rewriting operation mode, the buffer circuit 60 is disabled, and at the same time, the general-purpose I/O port terminal of the MPU 40 and the JTAG port terminal of the PLD 10 are connected to each other such that the MPU 40 can rewrite configuration data of the PLD 10.

As mentioned above, the electronic apparatus 100 and the rewriting method of this embodiment attain the effect of the first embodiment and further attain the following effect.

Since the MPU 40 can change an access destination of the general-purpose I/O port to either the PLD 10 or the memory 95, there is no need to increase a general-purpose I/O port.

### Third Embodiment

An electronic apparatus of a third embodiment has the configuration of the electronic apparatus of the first embodiment, and further comprises a configuration in which the MPU confirms outputs of the port 1 terminal and the port 2 terminal of the PLD. In the following, an explanation for the same configuration as that of the first embodiment is omitted.

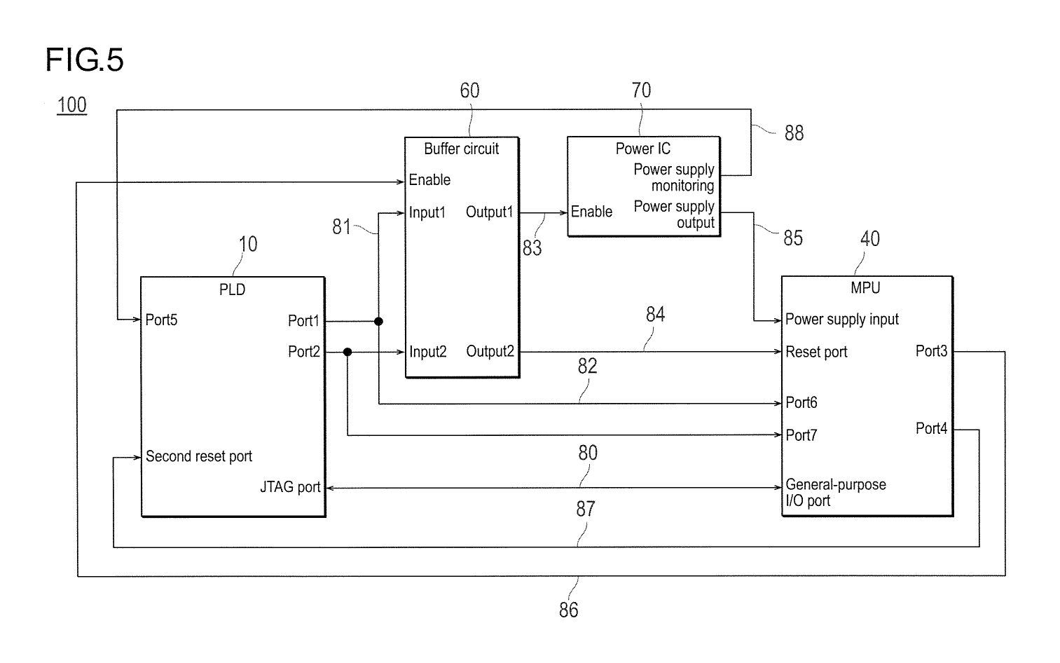

FIG. 5 is a block diagram illustrating a rough configuration of an electronic apparatus comprising a PLD according to the third embodiment. As illustrated in FIG. 5, in this embodiment, the MPU 40 comprises a port 6 terminal and a port 7 terminal which are connected to the port 1 terminal and port 2 terminal of the PLD 10, respectively.

In this embodiment, rewriting data of configuration data is transmitted from the general-purpose port of the MPU 40 to the JTAG port of the PLD 10 using a JTAG protocol in a similar manner to that of the first embodiment. The MPU 40 rewrites configuration data of the PLD 10, and then, verifies the data. In addition, the MPU 40 outputs a PLD reset signal from the port 4 terminal to reset the PLD 10, and, after a sufficient time for resetting the PLD 10, cancels the reset.

The MPU 40 confirms whether rewriting of configuration data of the PLD 10 is appropriately executed or not by confirming whether the logics of signals which are output from the port 1 terminal and port 2 terminal of the PLD 10 and timings thereof are appropriate or not.

As mentioned above, in this embodiment, power supply and reset sequences concerning start-up of the MPU 40 are directly confirmed through the port 6 terminal and the port 7 terminal.

As mentioned above, the electronic apparatus 100 and the rewriting method of this embodiment attain the effects of the first and second embodiments, and further attain the following effect.

Power supply and reset sequences concerning start-up of the MPU 40 are directly confirmed through the port 6 terminal and the port 7 terminal to detect in advance the case in which the MPU 40 cannot start up, thereby executing rewriting of the PLD 10 again. Accordingly, even when the MPU 40 fails to rewrite configuration data of the PLD 10, the MPU 40 can avoid not starting up.

As mentioned above, in the above-mentioned embodiments, electronic apparatuses comprising a PLD of the present invention have been described. However, needless to be mentioned, the present invention can be suitably added, modified, and abbreviated by those skilled in the art within its technical spirit.

For example, in the first to third embodiments, cases in which a PLD controls power supply and reset of an MPU have been described. However, the present invention is not limited to cases in which the PLD controls power supply and reset of the MPU, and can be applied to cases in which the PLD controls power supply and reset of a variety of devices.

In the above-mentioned first to third embodiments, cases in which the PLD controls both power supply and reset of the MPU. However, the present invention is not limited to cases in which the PLD controls both power supply and reset of the MPU, and can also be applied to cases in which the PLD controls at least one of power supply and reset of the MPU.

In the above-mentioned second embodiment, cases in which an access destination of the general-purpose I/O port of the MPU is a memory in a normal operation mode have been described. However, the present invention is not limited to cases in which an access destination of the general-purpose I/O port of the MPU is a memory in a normal operation mode, and can be applied to cases in which an access destination of the general-purpose I/O port of the MPU is another device.

What is claimed is:

1. An electronic apparatus comprising:
a microprocessor;
a programmable logic circuit device which controls at least one of power supply and reset of the microprocessor; and
a signal interruption unit which interrupts a control signal for controlling at least one of power supply and reset of the microprocessor by the programmable logic circuit device, while the microprocessor rewrites circuit configuration data of the programmable logic circuit device.

2. The electronic apparatus as claimed in claim 1, wherein
the programmable logic circuit device incorporates a rewritable nonvolatile memory and the rewritable nonvolatile memory stores the circuit configuration data.

3. The electronic apparatus as claimed in claim 1, wherein
the signal interruption unit cancels interruption of the control signal after completion of rewriting circuit configuration data of the programmable logic circuit device, and
the programmable logic circuit device initializes the whole electronic apparatus after the signal interruption unit cancels interruption of the control signal.

4. The electronic apparatus as claimed in claim 1, wherein
the programmable logic circuit device controls at least one of power supply and reset of a device comprising the microprocessor.

5. The electronic apparatus as claimed in claim 1, wherein
the microprocessor comprises two operation modes, a normal operation mode and a PLD rewriting operation mode, and
while the microprocessor rewrites circuit configuration data of the programmable logic circuit device when the operation mode is the PLD rewriting operation mode,
the microprocessor executes read/write on a device other than the programmable logic circuit device when the operation mode is the normal operation mode.

6. The electronic apparatus as claimed in claim 5, wherein
the electronic apparatus further comprises:
a storage unit as the other device; and
a selection unit which selects any of the programmable logic circuit device and the storage unit depending on the operation mode.

7. The electronic apparatus as claimed in claim 1, wherein
the signal interruption unit comprises a tri-state buffer to which the control signal is input and which outputs to the microprocessor, and
while, when the operation mode is the PLD rewriting operation mode, the tri-state buffer is in a high impedance state and therefore the control signal is interrupted from the microprocessor,
when the operation mode is the normal operation mode, the tri-state buffer is in a conductive state and therefore the control signal is input to the microprocessor.

8. The electronic apparatus as claimed in claim 7, wherein
an electric power is supplied to the tri-state buffer from the same power source as a power source which supplies an electric power to the programmable logic circuit device.

9. The electronic apparatus as claimed in claim 7, wherein
a pull-up resistor or a pull-down resistor is connected to an output terminal of the tri-state buffer, and
when the tri-state buffer is in a high impedance state, the output terminal is pulled up or pulled down such that an operation of the microprocessor continues.

10. The electronic apparatus as claimed in claim 7, wherein
a pull-up resistor or a pull-down resistor is connected to an input terminal of the tri-state buffer, and
when the control signal is unstable, the input terminal is pulled up or pulled down such that an operation of the microprocessor is not started.

11. The electronic apparatus as claimed in claim 7, wherein
a pull-up resistor or a pull-down resistor is connected to an enable terminal of the tri-state buffer, and
the enable terminal is pulled up or pulled down such that the tri-state buffer is in an enable state.

12. The electronic apparatus as claimed in claim 1, wherein
the signal interruption unit comprises an analog switch to which the control signal is input and which outputs to the microprocessor, and
while, when the operation mode is a PLD rewriting operation mode, the analog switch is in a high impedance state and therefore the control signal is interrupted from the microprocessor,
when the operation mode is the normal operation mode, the analog switch is in a conductive state and therefore the control signal is input to the microprocessor.

13. The electronic apparatus as claimed in claim 12, wherein
an electric power is supplied to the analog switch from the same power source as a power source which supplies an electric power to the programmable logic circuit device.

14. The electronic apparatus as claimed in claim 12, wherein
a pull-up resistor or a pull-down resistor is connected to an output terminal of the analog switch, and
when the analog switch is in a high impedance state, the output terminal is pulled up or pulled down such that an operation of the microprocessor continues.

15. The electronic apparatus as claimed in claim 12, wherein
a pull-up resistor or a pull-down resistor is connected to an input terminal of the analog switch, and
the input terminal is pulled up or pulled down such that an operation of the microprocessor is not started when the control signal is unstable.

16. The electronic apparatus as claimed in claim 12, wherein
a pull-up resistor or a pull-down resistor is connected to an enable terminal of the analog switch, and
the enable terminal is pulled up or pulled down such that the analog switch is in an enable state.

17. The electronic apparatus as claimed in claim 12, wherein
a pull-up resistor or a pull-down resistor of an input terminal of the analog switch and a pull-up resistor or a pull-down resistor of an output terminal of the analog switch are determined such that the control signal is in a logic level by which an operation of the microprocessor is not started by the resistance ratio determined by each of the resistance values.

18. The electronic apparatus as claimed in claim 1, wherein
the control signal is either high level or low level output of LVTTL or a high impedance output by an open collector.

19. A method of rewriting circuit configuration data of the programmable logic circuit device of an electronic apparatus comprising a microprocessor and a programmable logic circuit device which controls at least one of power supply and reset of the microprocessor, the method comprising the steps of:
acquiring circuit configuration data for rewriting the programmable logic circuit device;
interrupting a control signal for controlling at least one of power supply and reset of the microprocessor by the programmable logic circuit device; and
rewriting circuit configuration data of the programmable logic circuit device by the microprocessor.

20. The rewriting method as claimed in claim 19, further comprising the step of:
after the step of rewriting circuit configuration data of the programmable logic circuit device,
reading the rewritten circuit configuration data and verifying the data.

21. The rewriting method as claimed in claim 19, further comprising the steps of:
after the step of rewriting circuit configuration data of the programmable logic circuit device,
resetting the programmable logic circuit device;
cancelling reset of the programmable logic circuit device;
confirming behavior of the control signal;
cancelling interruption of the control signal; and
initializing the whole electronic apparatus.

22. The rewriting method as claimed in claim 21, wherein
in the step of confirming behavior of the control signal,
at least a signal concerning start-up or operation of the microprocessor is confirmed.

23. A computer readable recording medium storing a rewriting program causing a microprocessor to execute the rewriting method as claimed in claim 19.
